(19) United States
(12) Patent Application Publication
(10) Pub. No.: US 2024/0094651 A1
(43) Pub. Date: Mar. 21, 2024

(54) ELECTROSTATIC CHARGE IMAGE DEVELOPING CARRIER, ELECTROSTATIC CHARGE IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Karin SAKAI, Kanagawa (JP); Kazutsuna SASAKI, Kanagawa (JP); Yosuke TSURUMI, Kanagawa (JP); Yasuo KADOKURA, Kanagawa (JP); Takuro WATANABE, Kanagawa (JP)

(73) Assignee: FUJIFILM Business Innovation Corp., Tokyo (JP)

(21) Appl. No.: 18/324,987

(22) Filed: May 28, 2023

(30) Foreign Application Priority Data
Sep. 9, 2022 (JP) 2022-143841

(51) Int. Cl. G03G 9/08; G03G 9/087; G03G 15/08

(52) U.S. Cl. CPC G03G 9/0819; G03G 9/08755; G03G 9/08797; G03G 15/0875

(57) ABSTRACT

An electrostatic charge image developing carrier includes a core material and a resin coating layer that contains strontium titanate particles and coats the core material, in which a content of the strontium titanate particles is 10% by mass or more and 55% by mass or less with respect to a total mass of the resin coating layer, and a proportion of strontium atoms within a surface of the resin coating layer, the proportion being determined by X-ray photoelectron spectroscopy, is 0.2 at % or more and 1.0 at % or less.

### CROSS-REFERENCE TO RELATED APPLICATIONS

This application is based on and claims priority under 35 USC 119 from Japanese Patent Application No. 2022-143841 filed Sep. 9, 2022.

### BACKGROUND

### (i) Technical Field

The present invention relates to an electrostatic charge image developing carrier, an electrostatic charge image developer, a process cartridge, an image forming apparatus, and an image forming method.

### (ii) Related Art

JP2021-51216A discloses an electrostatic charge image developing carrier having a core material and a resin coating layer that contains nitrogen-containing resin particles and inorganic oxide particles and coats the core material, in which a surface exposure rate of the nitrogen-containing resin particles is 0.8% or more and 3.0% or less.

JP2019-159124A discloses an electrostatic charge image developing carrier containing resin-coated magnetic particles which have magnetic particles and a resin layer coating the magnetic particles and strontium titanate particles which include primary particles having an average circularity of 0.82 or more and 0.94 or less and in which cumulative 84% of particles have a circularity more than 0.92.

### SUMMARY

In order to improve the charging performance of the carrier, the resin coating layer of the carrier has been studied. For example, for the purpose of increasing the charge level, addition of functional groups to the resin in the resin coating layer and addition of nitrogen-containing fine particles are being performed (JP2021-51216A and the like). Furthermore, in order to improve the charge distribution and the charge responsiveness during the addition of a toner, the addition of carbon black, conductive powder, and the like has been studied.

However, regarding the charge transfer properties under a high humidity, there are problems in charging characteristics. In a case where a total of 50,000 or more sheets are printed for a long period of time in a high-humidity environment where the internal humidity of an image forming apparatus is 70% or higher at a high image density such that the proportion of images within the surface of a piece of paper is 20% or the like, due to the cloud that occurs in the apparatus by the reduction in charge, sometimes the toner consumption increases.

Aspects of non-limiting embodiments of the present disclosure relate to a carrier that has a resin coating layer containing strontium titanate particles, the carrier being further inhibited from undergoing charge reduction and further suppressing the increase in toner consumption, compared to a carrier in which the content of strontium titanate particles is less than 10% by mass or more than 55% by mass with respect to the total mass of a resin coating layer or a carrier in which the proportion of strontium atoms within the surface of a resin coating layer is less than 0.2 at % or more than 1.0 at %.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrostatic charge image developing carrier that includes a core material and a resin coating layer containing strontium titanate particles and coating the core material, in which a content of the strontium titanate particles is 10% by mass or more and 55% by mass or less with respect to a total mass of the resin coating layer, and a proportion of strontium atoms within a surface of the resin coating layer, the proportion being determined by X-ray photoelectron spectroscopy, is 0.2 at % or more and 1.0 at % or less.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

Hereinafter, exemplary embodiments of the invention will be described. The following descriptions, examples, and the like merely illustrate the exemplary embodiments, and do not restrict the scope of the invention.

In the present disclosure, unless otherwise specified, a range of numerical values described using “to” represents a range including the numerical values listed before and after “to” as the minimum value and the maximum value respectively. Furthermore, in the present disclosure, in a case where the amount of each component in a composition is mentioned, and there are two or more substances corresponding to each component present in the composition, unless otherwise specified, the amount of each component means the total amount of two or more substances present in the composition.

In the present disclosure, “electrostatic charge image developing carrier” will be simply described as “carrier” in some cases, “electrostatic charge image developing toner” will be simply described as “toner” in some cases, and “electrostatic charge image developer” will be simply described as “developer” in some cases.

Electrostatic Charge Image Developing Carrier

The electrostatic charge image developing carrier according to the present exemplary embodiment has a core material and a resin coating layer that contains strontium titanate particles and coats the core material, in which a content of the strontium titanate particles is 10% by mass or more and 55% by mass or less with respect to a total mass of the resin coating layer, and a proportion of strontium atoms within a surface of the resin coating layer, the proportion being determined by X-ray photoelectron spectroscopy, is 0.2 at % or more and 1.0 at % or less.

In order to improve the charging performance of an electrostatic charge image developing carrier, a resin coating layer that coats a core material of the carrier is being studied. In a case where a total of 50,000 or more sheets are printed for a long period of time in a high-humidity environment where the internal humidity of an image forming apparatus is 70% or higher at a high image density such that the proportion of images within the surface of a piece of paper is 20% or the like, due to the cloud that occurs in the apparatus by the reduction in charge of the carrier, sometimes the toner consumption increases.

The addition of functional groups to the resin in the resin coating layer or the addition of fine nitrogen resin particles to the inside of the layer, which have been performed in the related art to improve charging properties, is likely to lead to charge leakage under a high humidity. Furthermore, in order to improve the charge distribution and the charge responsiveness during the addition of a toner, the addition of carbon black or conductive powder has been considered. The addition of carbon black or the like improves charge initiation, but is likely to lead to charge leakage due to the low resistance of the carbon black or the like. In addition, an external additive or the like migrates to the resin coating layer from the toner and contaminates the resin coating layer, which results in the deterioration of a charger transferability as well.

Having the above configuration, the carrier according to the present exemplary embodiment may maintain the charge transferability and has excellent charge initiation even in a high-humidity environment where it is difficult to maintain charger transfer properties and initiate charging, and may suppress the increase in toner consumption. The following is presumed as the mechanism.

In the present exemplary embodiment, the resin coating layer contains strontium titanate particles containing a strontium element having low electronegativity. Due to the strontium titanate, the charge transferability is enhanced, and the reduction in charge under a high humidity may be suppressed. Furthermore, by controlling the resistance of the strontium titanate, it is possible to control the charge initiation.

The order of resistance is silica>alumina>strontium titanate>titanium. Therefore, having a too high resistance, silica or alumina has poor chargeability. In contrast, having too low resistance, titanium is likely to cause charge leakage. However, strontium titanate has an appropriate resistance that is in between the resistances of the above compounds. Presumably, strontium titanate is good for these reasons, for example.

Particularly, in order to maintain charge transfer properties and improve charge initiation, it is necessary to increase the proportion of strontium titanate present within the surface of the resin coating layer, and to satisfy a configuration condition that the content of strontium titanate in the resin coating layer and the abundance ratio of strontium atoms within the surface of the resin coating layer need to be in specific ranges.

Hereinafter, the configuration of the carrier according to the present exemplary embodiment will be specifically described.

Core Material

The electrostatic charge image developing carrier according to the present exemplary embodiment includes a core material.

The core material is not particularly limited as long as the core material has magnetism, and known materials used as a core material of a carrier are used.

Examples of the core material include particulate magnetic powder (magnetic particles); magnetic particles impregnated with a resin obtained by impregnating porous magnetic powder with a resin; resin particles having dispersed magnetic powder in which magnetic powder is dispersed in and mixed with a resin; and the like. One core material may be used alone, or two or more core materials may be used in combination.

Examples of the magnetic particles include particles of magnetic metals such as iron, nickel, and cobalt; magnetic oxides such as ferrite and magnetite; and the like. The magnetic particles are, for example, preferably magnetic oxide particles.

As the magnetic particles in the present exemplary embodiment, for example, ferrite particles are preferable.

In the present exemplary embodiment, it is preferable that the ferrite particles contain, for example, at least one compound selected from calcium oxide and strontium oxide. Presumably, calcium oxide and strontium oxide are likely to be contained in the surface of the ferrite particles, and in a case where a calcium element or a strontium element is present within the surface of the ferrite particles, leakage of charge from the ferrite particles may be suppressed, which may allow the carrier surface to be charged to a high level. Such a carrier inhibits a toner from being charged to a low level in a developing device. As a result, fogging is further suppressed, and fine line reproducibility is improved (for example, thickening, crushing, or blurring of fine lines is suppressed). This effect is markedly exhibited in a case where high-concentration and high-density monochromatic images are repeatedly formed at a high speed and then low-density images of the same color are formed.

In the present exemplary embodiment, for example, the ferrite particles preferably contain at least one compound selected from calcium oxide and strontium oxide, and the total content of a calcium element and a strontium element is preferably 0.1% by mass or more and 2.0% by mass or less with respect to the total mass of the ferrite particles. In a case where the total content of the calcium element and the strontium element is 0.1% by mass or more with respect to the total mass of the ferrite particles, charge leakage from the ferrite particles is efficiently suppressed. In a case where the total content of the calcium element and the strontium element is, for example, 2.0% by mass or less with respect to the total mass of the ferrite particles, the crystal structure of the ferrite particles is organized, and the resistance and magnetic susceptibility fall into preferable ranges. As a result, fogging is further suppressed, and fine line reproducibility is improved (for example, thickening, crushing, or blurring of fine lines is suppressed).

In this respect, the total content of the calcium element and the strontium element with respect to the total mass of the ferrite particles is, for example, preferably 0.1% by mass or more and 2.0% by mass or less, more preferably 0.2% by mass or more and 1.5% by mass or less, and even more preferably 0.5% by mass or more and 1.2% by mass or less.

In the present exemplary embodiment, the ferrite particles contain calcium oxide, and for example, the content of the calcium element is preferably 0.2% by mass or more and 2.0% by mass or less with respect to the total mass of the ferrite particles. In a case where the content of the calcium element is 0.2% by mass or more with respect to the total mass of the ferrite particles, charge leakage from the ferrite particles is efficiently suppressed. In a case where the content of the calcium element is, for example, 2.0% by mass or less with respect to the total mass of the ferrite particles, the crystal structure of the ferrite particles is organized, and the resistance and magnetic susceptibility fall into preferable ranges. As a result, fogging is further suppressed, and fine line reproducibility is improved (for example, thickening, crushing, or blurring of fine lines is suppressed).

In this respect, the content of the calcium element with respect to the total mass of the ferrite particles is, for example, preferably 0.2% by mass or more and 2.0% by mass or less, more preferably 0.5% by mass or more and 1.5% by mass or less, and even more preferably 0.5% by mass or more and 1.0% by mass or less.

In the present exemplary embodiment, the ferrite particles contain strontium oxide, and for example, the content of a strontium element with respect to the total mass of the ferrite particles is preferably 0.1% by mass or more and 1.0% by mass or less. In a case where the content of the strontium element is 0.1% by mass or more with respect to the total mass of the ferrite particles, charge leakage from the ferrite particles is efficiently suppressed. In a case where the content of the strontium element is, for example, 1.0% by mass or less with respect to the total mass of the ferrite particles, the crystal structure of the ferrite particles is organized, and the resistance and magnetic susceptibility fall into preferable ranges. As a result, fogging is further suppressed, and fine line reproducibility is improved (for example, thickening, crushing, or blurring of fine lines is suppressed).

In this respect, the content of the strontium element with respect to the total mass of the ferrite particles is, for example, preferably 0.1% by mass or more and 1.0% by mass or less, more preferably 0.4% by mass or more and 1.0% by mass or less, and even more preferably 0.5% by mass or more and 0.8% by mass or less.

The contents of the calcium element and strontium element contained in the ferrite particles are measured by X-ray fluorescence analysis. The X-ray fluorescence analysis is performed on the ferrite particles by the following method.

By using an X-ray fluorescence spectrometer (manufactured by Shimadzu Corporation, XRF1500) under the conditions of X-ray output: 40 V/70 mA, measurement area: diameter of 10 mm, and measurement time: 15 minutes, qualitative and quantitative analysis is performed. The element to be analyzed is selected based on the element detected by the qualitative analysis. Iron (Fe), manganese (Mn), magnesium (Mg), calcium (Ca), strontium (Sr), oxygen (O), and carbon (C) are generally selected. The mass ratio (%) of each element is calculated with reference to the separately created calibration curve data.

The volume-average particle size of the magnetic particles is, for example, 10 μm or more and 500 μm or less, preferably 20 μm or more and 180 μm or less, and more preferably 25 μm or more and 60 μm or less.

As for the magnetic force of the magnetic particles, the saturation magnetization of the magnetic particles in a magnetic field of 3,000 Oe is, for example, 50 emu/g or more, and preferably 60 emu/g or more. The saturation magnetization is measured using a vibrating sample magnetometer VSMP10-15 (manufactured by TOEI INDUSTRY CO., LTD.). The measurement sample is packed in a cell having an inner diameter of 7 mm and a height of 5 mm and set in the aforementioned magnetometer. For the measurement, a magnetic field is applied and swept up to 3,000 Oe. Next, the applied magnetic field is reduced, and a hysteresis curve is created on recording paper. Saturation magnetization, residual magnetization, and holding force are obtained from the data of the curve.

The electrical volume resistance (volume resistivity) of the magnetic particles is, for example, 10⁵ Ω·cm or more and 10⁹ Ω·cm or less, and preferably 10⁷ Ω·cm or more and 10⁹ Ω·cm or less.

The electrical volume resistance (Ω·cm) of the magnetic particles is measured as follows. A measurement target is placed flat on the surface of a circular jig on which a 20 cm² electrode plate is disposed, such that the measurement target has a thickness of about 1 mm or more and 3 mm or less and forms a layer. The above 20 cm² electrode plate is placed on the layer such that the layer is sandwiched between the electrode plates. In order to eliminate voids between measurement targets, a load of 4 kg is applied onto the electrode plates arranged on the layer, and then the thickness (cm) of the layer is measured. Both the upper and lower electrodes of the layer are connected to an electrometer and a high-voltage power supply device. A high voltage is applied to both electrodes such that an electric field of 103.8 V/cm is generated, and the current value (A) flowing at this time is read. The volume resistivity is measured in an environment at a temperature of 20° C. and a humidity of 50% RH. The formula for calculating the electrical volume resistance (Ω·cm) of the measurement target is as follows.

R=E×20/(I−I₀)/L

In the above formula, R represents an electrical volume resistance (Ω·cm) of the measurement target, E represents an applied voltage (V), I represents a current value (A), I₀ represents a current value (A) at an applied voltage of 0 V, and L represents a thickness of the layer (cm). The coefficient 20 represents an area (cm²) of the electrode plate.

Resin Coating Layer

The resin coating layer according to the present exemplary embodiment contains strontium titanate particles.

The resin coating layer according to the present exemplary embodiment is a resin layer that coats the core material.

Binder Resin

Examples of the binder resin configuring the resin coating layer include a styrene⋅acrylic acid copolymer; a polyolefin-based resin such as polyethylene or polypropylene; a polyvinyl-based or polyvinylidene-based resins such as polystyrene, an acrylic resin, polyacrylonitrile, polyvinyl acetate, polyvinyl alcohol, polyvinyl butyral, polyvinyl chloride, polyvinylcarbazole, polyvinylether, or polyvinylketone; a vinyl chloride vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea⋅formaldehyde resin; an epoxy resin; and the like. As the resin configuring the resin coating layer, one resin may be used alone or two or more resins may be used in combination.

It is preferable that the resin configuring the resin coating layer contain, for example, an alicyclic (meth)acrylic resin. In a case where the resin coating layer contains an alicyclic acrylic resin, the dispersibility of inorganic oxide particles contained in the resin coating layer is likely to be further improved, and resin pieces containing the inorganic oxide particles tend to be efficiently generated. As a result, the density unevenness of the image tends to be further suppressed.

As polymerization components of the alicyclic (meth)acrylic resin, for example, a lower alkyl ester of (meth)acrylic acid (for example, a (meth)acrylic acid alkyl ester having an alkyl group having 1 or more and 9 or less carbon atoms) is preferable. Specifically, examples thereof include methyl (meth)acrylate, ethyl (meth)acrylate, propyl (meth)acrylate, butyl (meth)acrylate, hexyl (meth)acrylate, cyclohexyl (meth)acrylate, 2-ethylhexyl (meth)acrylate, 2-(dimethylamino)ethyl (meth)acrylate, and the like.

From the viewpoint of further suppressing density unevenness of the image, for example, the alicyclic acrylic resin preferably contains at least one component selected from the group consisting of methyl (meth)acrylate, cyclohexyl (meth)acrylate, and 2-(dimethylamino)ethyl (meth)acrylate as a polymerization component, and more preferably contains at least one of methyl (meth)acrylate or cyclohexyl (meth)acrylate as a polymerization component, among the above. One polymerization component of the alicyclic acrylic resin may be used alone, or two or more polymerization components of the alicyclic acrylic resin may be used in combination.

Owing to the steric hindrance of alicyclic functional groups, the alicyclic (meth)acrylic resin prevents water from affecting the polarization component of the bond between a carbon atom and an oxygen atom. It is preferable that the alicyclic (meth)acrylic resin contain, for example, cyclohexyl (meth)acrylate as a polymerization component, because this component can inhibit water from affecting environmental changes.

The content of cyclohexyl (meth)acrylate contained in the alicyclic (meth)acrylic resin is, for example, preferably 75 mol % or more and 100 mol % or less, more preferably 90 mol % or more and 100 mol % or less, and even more preferably 95 mol % or more and 100 mol % or less.

Examples of the method of forming the resin coating layer on the surface of the core material include a wet manufacturing method and a dry manufacturing method. The wet manufacturing method is a manufacturing method using a solvent that dissolves or disperses the resin configuring the resin coating layer. On the other hand, the dry manufacturing method is a manufacturing method that does not use the above solvent.

Specifically, examples of the wet manufacturing method include an immersion method of immersing the core material in a resin solution for forming a resin coating layer; a spray method of spraying the resin solution for forming a resin coating layer to the surface of the core material; a fluidized bed method of spraying the resin solution for forming a resin coating layer to the core material that is in a state of being fluidized in a fluidized bed; a kneader coater method of mixing the core material with the resin solution for forming a resin coating layer in a kneader coater and removing solvents; and the like.

The resin solution for forming a resin coating layer used in the wet manufacturing method is prepared by dissolving or dispersing a resin and other components in a solvent. The solvent is not particularly limited as long as the solvent dissolves or disperses a resin. For example, as the solvent, aromatic hydrocarbons such as toluene and xylene; ketones such as acetone and methyl ethyl ketone; ethers such as tetrahydrofuran and dioxane; and the like are used.

Examples of the dry manufacturing method include a method of heating a mixture of a core material and a resin for forming a resin coating layer in a dry state to form a resin coating layer. Specifically, for example, a core material and a resin for forming a resin coating layer are mixed together in a gas phase and melted by heating to form a resin coating layer.

The thickness of the resin coating layer is, for example, preferably 0.1 μm or more and 10 μm or less, more preferably 0.2 μm or more and 5 μm or less, and even more preferably 0.3 μm or more and 3 μm or less.

The thickness of the resin coating layer is measured by the following method. The carrier is embedded in an epoxy resin or the like and cut with a diamond knife or the like to prepare a thin slice. The thin slice is observed with a transmission electron microscope (TEM) or the like, and cross-sectional images of a plurality of carrier particles are captured. The thickness of the coating layer is measured at 20 locations in the cross-sectional images of the carrier particles, and the average thereof is adopted.

Strontium Titanate Particles

The strontium titanate particles contained in the resin coating layer in the present exemplary embodiment will be described.

Content

In the resin coating layer, the content of the strontium titanate particles with respect to the total mass of the resin coating layer is, for example, 10% by mass or more and 55% by mass or less, preferably 15% by mass or more and 45% by mass or less, and more preferably 20% by mass or more and 40% by mass or less. In a case where the content of the strontium titanate particles is in these ranges, it is possible to improve the charge level and charge initiation of the carrier under a high humidity.

Volume-Average Particle Size

The volume-average particle size of the strontium titanate particles is, for example, preferably 5 nm or more and 50 nm or less, more preferably 10 nm or more and 45 nm or less, and even more preferably 15 nm or more and 30 nm or less. In a case where the volume-average particle size is too small, the strontium titanate particles are likely to be buried in the resin coating layer, which tends to make it difficult to uniformly disperse the particles on the surface. In a case where the volume-average particle size is too large, the strontium titanate particles are likely to be released from the resin coating layer, which tends to make it difficult for the carrier surface to maintain a high charge level.

The volume-average particle size of the strontium titanate particles is measured by observing a cross section of the carrier cut along the thickness direction with a scanning microscope and performing image analysis on the strontium titanate particles. Specifically, for each carrier, 50 strontium titanate particles are observed with a scanning microscope, the longest diameter and the shortest diameter of each particle are measured by image analysis on the strontium titanate particles, and an equivalent spherical diameter is measured from the median. The equivalent spherical diameter is measured for 100 carriers. Then, the diameter (D50v) taking up 50% in a volume-based cumulative frequency of the obtained equivalent spherical diameter is adopted as the volume-average particle size of the strontium titanate particles.

Ratio (D/T) of Volume-Average Particle Size D to Resin Coating Layer Thickness T

In a case where D (nm) represents a volume-average particle size of the strontium titanate particles, and T (nm) represents a thickness of the resin coating layer, from the viewpoint of suppressing charge reduction of the carrier, D/T is, for example, preferably 0.0033 or more and 0.050 or less, more preferably 0.0050 or more and 0.040 or less, and even more preferably 0.010 or more and 0.030 or less.

Proportion of Strontium Atoms within Surface of Resin Coating Layer

Regarding strontium atoms that the strontium titanate particles contained in the resin coating layer have, for example, a proportion of the atoms within the surface of the resin coating layer obtained by X-ray photoelectron spectroscopy is 0.2 at % or more and 1.0 at % or less, preferably 0.4 at % or more and 0.8 at % or less, and more preferably 0.5 at % or more and 0.7 at % or less. In a case where the proportion of the strontium atoms in these ranges, it is possible to improve the charge level and charge initiation of the carrier under a high humidity. Particularly, combining the proportion of the strontium atoms with the aforementioned content of the strontium titanate particles with respect to the total mass of the resin coating layer produces marked effects.

The proportion of strontium atoms within the surface of the resin coating layer is determined by X-ray photoelectron spectroscopy in the following manner.

All the atoms present within the surface of the resin coating layer of the carrier are detected with an X-ray photoelectron spectroscope (XPS, JPS-9000MX, manufactured by JEOL Ltd.). Then, the ratio of the peak area of strontium atoms to the total peak area of all atoms present within the surface of the resin coating layer is calculated. This measurement is performed on 10 random carriers, an arithmetic mean of the ratios of the peak areas of the strontium atoms in the carriers is calculated and adopted as the proportion of the strontium atoms within the surface of the resin coating layer.

There is no particular restriction on the method of making the proportion of strontium atoms within the surface of the resin coating layer fall into the above range. For example, in a case where the resin coating layer also contains nitrogen-containing resin particles that will be described later, examples of the method include (1) method of adjusting the mixing amount of the strontium titanate particles and the nitrogen-containing resin particles in manufacturing the carrier; (2) coating the core material with a solution for forming a resin coating layer containing the strontium titanate particles and the nitrogen-containing resin particles in manufacturing the carrier such that the strontium titanate particles are dispersed on the surface of the resin coating layer, for example, in a preferable range by the difference in specific gravity between the strontium titanate particles and the nitrogen-containing resin particles; (3) method of preparing a solution 1 for forming a resin coating layer that contains nitrogen-containing resin particles and a resin and a solution 2 for forming a resin coating layer that contains strontium titanate particles and a resin and coating the core material with the solution 1 for forming a resin coating layer and a solution 2 for forming a resin coating layer in this order in manufacturing the carrier; and the like.

Distribution in Depth Direction (Sr1/C1, Sr2/C2)

From the viewpoint of making strontium titanate stably exposed from the resin coating layer for a long period of time such that the charge reduction is suppressed for a long period of time, in a case where C1 represents carbon atoms derived from all components contained in a first region within 300 nm from a surface of the carrier in a depth direction, Sr1 represents strontium atoms derived from the strontium titanate particles contained in the first region, C2 represents carbon atoms derived from all components contained in a second region which is 300 nm away from the surface of the carrier in the depth direction and within 600 nm from the surface of the carrier in the depth direction, and Sr2 represents strontium atoms derived from the strontium titanate particles contained in the second region, for example, a ratio of Sr1 to C1 (Sr1/C1) is preferably lower than a ratio of Sr2 to C2 (Sr2/C2).

The ratio (Sr1/C1) of strontium atoms derived from the strontium titanate particles contained in the first region is determined as follows.

(1) In the same manner as the measurement of the aforementioned proportion of strontium atoms within the surface of the resin coating layer, all the atoms present within the carrier surface, that is, all atoms at a position 0 nm from the carrier surface are detected. Then, the ratio of the peak area of strontium atoms derived from the strontium titanate particles to the total peak area of carbon atoms derived from all the components present within the carrier surface is calculated.

(2) The carrier surface is etched to a position 150 nm away from the carrier surface in a depth direction of the resin coating layer, and all the atoms present at the position 100 nm away from the carrier surface in the depth direction of the resin coating layer are detected with an X-ray photoelectron spectroscope (XPS, JPS-9000MX, manufactured by JEOL Ltd.). Then, the ratio of the peak area of atoms derived from strontium atoms to the total peak area of carbon atoms derived from all the components present at the position 100 nm away from the carrier surface in the depth direction of the resin coating layer is calculated.

(3) In the same manner as in (2) described above, the ratio of the peak area of atoms derived from strontium atoms at a position 300 nm away from the carrier surface in the depth direction of the resin coating layer is calculated.

(4) “Arithmetic mean of the ratios of peak areas of atoms derived from strontium atoms” at positions 0 nm, 150 nm, and 300 nm away from the carrier surface is calculated.

(5) This measurement is performed for 10 random carriers, and the arithmetic mean of “arithmetic mean of the ratios of peak areas of atoms derived from strontium atoms” at each position is adopted as the ratio of strontium atoms Sr1 derived from the strontium titanate particles contained in the first region (Sr1/C1).

The ratio (Sr2/C2) of strontium atoms Sr2 derived from the strontium titanate particles contained in the second region is determined as follows.

(1) The carrier surface is etched to a position 450 nm away from the carrier surface in a depth direction of the resin coating layer, and all the atoms present at the position 100 nm away from the carrier surface in the depth direction of the resin coating layer are detected with an X-ray photoelectron spectroscope (XPS, JPS-9000MX, manufactured by JEOL Ltd.). Then, the ratio of the peak area of atoms derived from strontium atoms to the total peak area of carbon atoms derived from all the components present at the position 450 nm away from the carrier surface in the depth direction of the resin coating layer is calculated.

(2) In the same manner as in (1) described above, the ratio of the peak area of atoms derived from strontium atoms at a position 600 nm away from the carrier surface in the depth direction of the resin coating layer is calculated.

(3) “Arithmetic mean of the ratios of peak areas of atoms derived from strontium atoms” at positions 450 nm and 600 nm away from the carrier surface is calculated.

(4) This measurement is performed for 10 random carriers, and the arithmetic mean of “arithmetic mean of the ratios of peak areas of atoms derived from strontium atoms” at each position is adopted as the ratio of strontium atoms Sr2 derived from the strontium titanate particles contained in the second region (Sr2/C2).

As described above, in order to suppress the charge reduction for a long period of time, the ratio (Sr1/C1) of the strontium atoms Sr1 derived from the strontium titanate particles in the first region is, for example, preferably lower than the ratio (Sr2/C2) of the strontium atoms Sr2 derived from the strontium titanate particles in the second region. The difference (Sr2/C2−Sr1/C1) between the ratio (Sr2/C2) in the second region and the ratio (Sr1/C1) in the first region is, for example, preferably 0.003 or more, and more preferably 0.005 or more.

There is no particular restriction on the method of establishing, for example, a preferable relationship between the ratio (Sr1/C1) of the strontium atoms Sr1 derived from the strontium titanate particles in the first region and the ratio (Sr2/C2) of the strontium atoms Sr2 derived from the strontium titanate particles in the second region. In a case where the nitrogen-containing resin particles are additionally incorporated into the resin coating layer in manufacturing the carrier as will be described later, examples of the method include (1) method of adjusting the mixing amount of the strontium titanate particles and other nitrogen-containing resin particles or the like incorporated into the resin coating layer; (2) coating the core material with a solution for forming a resin coating layer containing strontium titanate particles and nitrogen-containing resin particles such that the nitrogen-containing resin particles are dispersed on the surface of the resin coating layer by the difference in specific gravity between the nitrogen-containing resin particles and the strontium titanate particles; (3) method of preparing a solution 1 for forming a resin coating layer that contains strontium titanate particles and a resin and a solution 2 for forming a resin coating layer that contains nitrogen-containing resin particles and a resin and coating the core material with the solution 1 for forming a resin coating layer and a solution 2 for forming a resin coating layer in this order; and the like.

Dopant

It is preferable that the strontium titanate particles used in the present exemplary embodiment be doped, for example, with metal atoms (hereinafter, also called a dopant) other than titanium and strontium. In a case where the strontium titanate particles contain the dopant, the crystallinity of the perovskite structure is reduced, and the strontium titanate particles have a roundish shape.

The dopant of the strontium titanate particles is not particularly limited as long as the dopant is a metal element other than titanium and strontium. For example, metal atoms are preferable which have an ionic radius that enables the metal atoms to enter the crystal structure configuring the strontium titanate particles when ionized. In this respect, the dopant of the strontium titanate particles is, for example, preferably metal atoms having an ion radius of 40 pm or more and 200 pm or less when ionized, and more preferably metal atoms having an ion radius of 60 pm or more and 150 pm or less when ionized.

Specifically, examples of the dopant of the strontium titanate particles include lanthanoid, silica, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, silver, and tin. As lanthanoid, for example, lanthanum and cerium are preferable. Among these, from the viewpoint of ease of doping and ease of control of the shape of the strontium titanate particles, for example, lanthanum is preferable.

From the viewpoint of preventing the strontium titanate particles from being excessively negatively charged, the dopant of the strontium titanate particles is, for example, preferably metal atoms having an electronegativity of 2.0 or less, and more preferably metal atoms having an electronegativity of 1.3 or less. In the present exemplary embodiment, the electronegativity is the Allred-Rochow electronegativity.

Examples of metal atoms preferable as the metal atoms having an electronegativity of 2.0 or less are shown below together with the electronegativity.

Examples of metal atoms having an electronegativity of 2.0 or less include lanthanum (1.08), magnesium (1.23), aluminum (1.47), silica (1.74), calcium (1.04), vanadium (1.45), chromium (1.56), manganese (1.60), iron (1.64), cobalt (1.70), nickel (1.75), copper (1.75), zinc (1.66), gallium (1.82), yttrium (1.11), zirconium (1.22), niobium (1.23), silver (1.42), indium (1.49), tin (1.72), barium (0.97), tantalum (1.33), rhenium (1.46), cerium (1.06), and the like.

From the viewpoint of allowing the strontium titanate particles to have the perovskite crystal structure and a roundish shape, in the strontium titanate particles, the amount of the dopant with respect to strontium is, for example, preferably in a range of 0.1 mol % or more and 20 mol % or less, more preferably in a range of 0.1 mol % or more and 15 mol % or less, and even more preferably in a range of 0.1 mol % or more and 10 mol % or less.

Water Content

It is preferable that the strontium titanate particles used in the present exemplary embodiment have, for example, a water content of 1.5% by mass or more and 10% by mass or less. In a case where the water content is 1.5% by mass or more and 10% by mass or less (for example, more preferably 2% by mass or more and 5% by mass or less), the resistance of the strontium titanate particles falls into an appropriate range, and the occurrence of fogging during image formation is suppressed.

In a case where the strontium titanate particles are manufactured by a wet manufacturing method, and the conditions (temperature and time) of a drying treatment are adjusted, the water content of the strontium titanate particles falls into the above range.

Furthermore, in a case where the surface of the strontium titanate particles is subjected to a hydrophobic treatment, the conditions of a drying treatment following the hydrophobic treatment may be adjusted such that the water content falls into the above range.

The water content of the strontium titanate particles is measured as follows.

A measurement sample (20 mg) is left to stand for 17 hours in a chamber at a temperature of 22° C./a relative humidity of 55% such that the sample is humidified. Then, in a room at a temperature of 22° C./a relative humidity of 55%, by a thermobalance (TGA-50 manufactured by Shimadzu Corporation), the sample is heated from 30° C. to 250° C. at a temperature rise rate of 30° C./min in nitrogen gas atmosphere, and a loss on heating (loss of mass caused by heating) is measured.

Thereafter, based on the measured loss on heating, the water content is calculated by the following equation.

Water content (% by mass)=(loss on heating from 30° C. to 250° C.)÷(mass of humidified sample not yet being heated)×100

Hydrophobic Treatment

From the viewpoint of improving the action of the strontium titanate particles, the strontium titanate particles used in the present exemplary embodiment are preferably, for example, strontium titanate particles with surface having undergone a hydrophobic treatment, and more preferably strontium titanate particles with surface having undergone a hydrophobic treatment using a silicon-containing organic compound.

Examples of the silicon-containing organic compound include an alkoxysilane compound, a silazane compound, silicone oil, and the like. Among these, for example, at least one compound selected from the group consisting of an alkoxysilane compound and silicone oil is preferable.

The silicon-containing organic compound will be specifically described in the section of manufacturing method of strontium titanate particles.

The content of a silicon-containing organic compound in the surface of the strontium titanate particles with respect to the mass of the strontium titanate particles is, for example, preferably 1% by mass or more and 50% by mass or less (for example, preferably 5% by mass or more and 40% by mass or less, more preferably 5% by mass or more and 30% by mass or less, and even more preferably 10% by mass or more and 25% by mass or less).

That is, the amount of hydrophobic treatment with the silicon-containing organic compound with respect to the mass of the strontium titanate particles is, for example, preferably 1% by mass or more and 50% by mass or less, more preferably 5% by mass or more and 40% by mass or less, even more preferably 5% by mass or more and 30% by mass or less, and particularly preferably 10% by mass or more and 25% by mass or less.

In a case where the amount of hydrophobic treatment is 1% by mass or more, the charge amount of the carrier can be secured even under a high temperature and a high humidity, and it is easy to suppress the occurrence of fogging. Furthermore, in a case where the amount of hydrophobic treatment is 50% by mass or less, the saturated charge amount of the carrier does not excessively increase even under a low temperature and a low humidity, and it is easy to suppress the occurrence of fogging. In addition, in a case where the amount of hydrophobic treatment is 30% by mass or less, it is easy to suppress the occurrence of aggregates resulting from the surface having undergone the hydrophobic treatment.

From the viewpoint of improving the action of the strontium titanate particles, within the surface of the strontium titanate particles having undergone the hydrophobic treatment, a mass ratio (Si/Sr) of silicon (Si) to strontium (Sr) calculated by the qualitative/quantitative X-ray fluorescence analysis is, for example, preferably 0.025 or more and 0.25 or less, and more preferably 0.05 or more and 0.20 or less.

The X-ray fluorescence analysis is performed on the surface of the strontium titanate particles having undergone the hydrophobic treatment, by the following method.

That is, by using an X-ray fluorescence spectrometer (manufactured by Shimadzu Corporation, XRF1500) under the conditions of an X-ray output: 40 V, 70 mA, measurement area: 10 mmΦ, and measurement time: 15 minutes, qualitative and quantitative analysis is performed. The atoms to be analyzed are oxygen (O), silicon (Si), titanium (Ti), strontium (Sr), and metal atoms (Me) other than titanium and strontium. From the total mass of each atom measured, a mass ratio (%) of each element is calculated with reference to the separately created calibration curve data from which each atom can be quantified.

Based on the mass ratio of silicon (Si) and the mass ratio of strontium (Sr) obtained by the above measurement, the mass ratio (Si/Sr) is calculated.

Manufacturing Method of Strontium Titanate Particles

The strontium titanate particles are manufactured by manufacturing strontium titanate particles and then, as necessary, performing a hydrophobic treatment on the surface thereof.

The manufacturing method of the strontium titanate particles is not particularly limited. However, from the viewpoint of controlling the particle size and shape, the manufacturing method is preferably, for example, a wet manufacturing method.

Manufacturing of Strontium Titanate Particles

The wet manufacturing method of the strontium titanate particles is, for example, a manufacturing method of causing a reaction in a state of adding an alkaline aqueous solution to a mixed solution of a titanium oxide source and a strontium source, and then performing an acid treatment. In this manufacturing method, the particle size of the strontium titanate particles is controlled by a mixing ratio between the titanium oxide source and the strontium source, the concentration of the titanium oxide source at the initial stage of reaction, the temperature and addition rate during the addition of the alkaline aqueous solution, and the like.

As the titanium oxide source, for example, a substance is preferable which is obtained by deflocculating a titanium compound hydrolysate by a mineral acid. Examples of the strontium source include strontium nitrate, strontium chloride, and the like.

The mixing ratio of the strontium source to the titanium oxide source that is expressed as SrO/TiO₂ molar ratio is, for example, preferably 0.9 or more and 1.4 or less, and more preferably 1.05 or more and 1.20 or less. The concentration of the titanium oxide source, which is TiO₂, at the initial stage of reaction is, for example, preferably 0.05 mol/L or more and 1.3 mol/L or less, and more preferably 0.5 mol/L or more and 1.0 mol/L or less.

In order to adjust the resistance of the strontium titanate particles, for example, it is preferable to add a dopant source to the mixed solution of the titanium oxide source and the strontium source. Examples of the dopant source include oxides of metals other than titanium and strontium. The metal oxide as a dopant source is added, for example, as a solution obtained by dissolving the metal oxide in nitric acid, hydrochloric acid, sulfuric acid, or the like. The amount of the dopant source added with respect to 100 mol of strontium is, for example, preferably an amount that makes the content of a metal as the dopant 0.1 mol or more and 10 mol or less, and more preferably an amount that makes the content of a metal as the dopant 0.5 mol or more and 10 mol or less.

Furthermore, the dopant source may be added at the time of addition of an alkaline aqueous solution to the mixed solution of the titanium oxide source and the strontium source. Even in this case, the metal oxide of the dopant source may be added as a solution obtained by dissolving the metal oxide in nitric acid, hydrochloric acid, or sulfuric acid.

As the alkaline aqueous solution, for example, an aqueous sodium hydroxide solution is preferable. The higher the temperature at which the alkaline aqueous solution is added, the better the crystallinity of the obtained strontium titanate particles tends to be. In the present exemplary embodiment, the temperature is, for example, preferably in a range of 6° C. or higher and 100° C. or lower.

The lower the addition rate of the alkaline aqueous solution, the larger the particle diameter of the obtained strontium titanate particles. The higher the addition rate of the alkaline aqueous solution, the smaller the particle diameter of the obtained strontium titanate particles. The addition rate of the alkaline aqueous solution with respect to the prepared raw materials is, for example, 0.001 equivalents/h or more and 1.2 equivalents/h or less, and preferably 0.002 equivalents/h or more and 1.1 equivalents/h or less.

After the alkaline aqueous solution is added, for the purpose of removing the unreacted strontium source, an acid treatment is performed. In the acid treatment, for example, by using hydrochloric acid, the pH of the reaction solution is adjusted to 2.5 to 7.0 and more preferably to 4.5 to 6.0.

After the acid treatment, the reaction solution is subjected to solid-liquid separation, and the solids are subjected to a drying treatment, thereby obtaining strontium titanate particles.

The water content of the strontium titanate particles is controlled by adjusting the conditions of the drying treatment for the solids.

Furthermore, in a case where the surface of the strontium titanate particles is subjected to a hydrophobic treatment, the conditions of a drying treatment following the hydrophobic treatment may be adjusted such that the water content is controlled.

As the drying conditions for controlling the water content, for example, the drying temperature is preferably 90° C. or higher and 300° C. or lower (for example, more preferably 100° C. or higher and 150° C. or lower), and the drying time is preferably 1 hour or more and 15 hours or less (for example, more preferably 5 hours or more and 10 hours or less).

Hydrophobic Treatment

The hydrophobic treatment performed on the surface of the strontium titanate particles is performed, for example, by preparing a treatment liquid by means of mixing a silicon-containing organic compound as a hydrophobic agent with a solvent, mixing the treatment liquid with the strontium titanate particles under stirring, and further continuing stirring.

After the surface treatment, for the purpose of removing the solvent of the treatment liquid, a drying treatment is performed.

Examples of the silicon-containing organic compound as a hydrophobic agent include an alkoxysilane compound, a silazane compound, a silicone oil, and the like.

Examples of the alkoxysilane compound as a hydrophobic agent include tetramethoxysilane, tetraethoxysilane; methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, vinyltriethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane; dimethyldimethoxysilane, dimethyldiethoxysilane, methylvinyldimethoxysilane, methylvinyldiethoxysilane, diphenyldimethoxysilane, diphenyldiethoxysilane; trimethylmethoxysilane, and trimethylethoxysilane.

Examples of the silazane compound as a hydrophobic agent include dimethyldisilazane, trimethyldisilazane, tetramethyldisilazane, pentamethyldisilazane, hexamethyldisilazane, and the like.

Examples of the silicone oil as a hydrophobic agent include silicone oils such as dimethylpolysiloxane, diphenylpolysiloxane, and phenylmethylpolysiloxane; reactive silicone oils such as amino-modified polysiloxane, epoxy-modified polysiloxane, carboxyl-modified polysiloxane, carbinol-modified polysiloxane, fluorine-modified polysiloxane, methacryl-modified polysiloxane, mercapto-modified polysiloxane, and phenol-modified polysiloxane; and the like.

Among these, as a hydrophobic agent, for example, an alkoxysilane compound is preferably used in view of difference in charging environment and fluidity improvement, and butyltrimethoxysilane is preferable in view of fluidity improvement.

The solvent used for preparing the aforementioned treatment liquid is, for example, preferably an alcohol (for example, methanol, ethanol, propanol, or butanol) in a case where the silicon-containing organic compound is an alkoxysilane compound or a silazane compound, or preferably hydrocarbons (for example, benzene, toluene, normal hexane, and normal heptane) in a case where the silicon-containing organic compound is a silicone oil.

In the treatment liquid, the concentration of the silicon-containing organic compound is, for example, preferably 1% by mass or more and 50% by mass or less, more preferably 5% by mass or more and 40% by mass or less, and even more preferably 10% by mass or more and 30% by mass or less.

As described above, the amount of the silicon-containing organic compound used in the hydrophobic treatment with respect to the mass of the strontium titanate particles is, for example, preferably 1% by mass or more and 50% by mass or less, more preferably 5% by mass or more and 40% by mass or less, even more preferably 5% by mass or more and 30% by mass or less, and particularly preferably 10% by mass or more and 25% by mass or less.

The strontium titanate particles with a surface having undergone a hydrophobic treatment are obtained in the above manner.

Nitrogen-Containing Resin Particles

In the present exemplary embodiment, for example, it is preferable that the resin coating layer further contain nitrogen-containing resin particles.

Examples of the nitrogen-containing resin particles include particles of a polymerized (meth)acrylic resin containing dimethylaminoethyl (meth)acrylate, dimethyl acrylamide, acrylonitrile, and the like; an amino resin such as urea, melamine, guanamine, or aniline; an amide resin; a urethane resin; and a copolymer of the above resin; and the like. From the viewpoint of further suppressing density unevenness of the image, for example, the nitrogen-containing resin particles preferably contain at least one kind of particles selected from the group consisting of an amino resin and a urethane resin as fine resin particles, more preferably contain amino resin particles as the fine resin particles, and even more preferably contain melamine resin particles as the fine resin particles, among the above. One kind of nitrogen-containing resin particles may be used alone, or two or more kinds of fine nitrogen-containing resin particles may be used in combination.

From the viewpoint of improving the charge retention properties of the carrier, a volume-average particle size of the nitrogen-containing resin particles according to the present exemplary embodiment is, for example, preferably 120 nm or more and 230 nm or less. For example, the volume-average particle size of is more preferably 140 nm or more and 220 nm or less. Particularly, in a case where the volume-average particle size of the nitrogen-containing resin particles is 120 nm or more, roughness is easily formed on the carrier surface. Therefore, the adhesion of external additives of the toner to the carrier tends to be physically further suppressed.

The volume-average particle size of the nitrogen-containing resin particles can be determined by the same method as the method of determining the volume-average particle size of the strontium titanate particles.

In a case where E (nm) represents a volume-average particle size of the nitrogen-containing resin particles according to the present exemplary embodiment, and T (nm) represents a thickness of the resin coating layer, from the viewpoint of improving charge retention properties of the carrier, for example, E/T is preferably 0.007 or more and 0.24 or less. For example, E/T is more preferably 0.01 or more and 0.24 or less, and even more preferably 0.02 or more and 0.24 or less.

From the viewpoint of improving charge retention properties of the carrier, the content of the nitrogen-containing resin particles according to the present exemplary embodiment with respect to the total mass of the resin coating layer is, for example, preferably 5% by mass or more and 30% by mass or less, more preferably 6% by mass or more and 20% by mass or less, and even more preferably 7% by mass or more and 15% by mass or less.

From the viewpoint of maintaining and stabilizing the charging characteristics of the carrier, a mass ratio P/W of a mass P of the nitrogen-containing resin particles to a mass W of the strontium titanate particles according to the present exemplary embodiment is, for example, preferably 0.091 or more and 3.00 or less. The mass ratio P/W is, for example, preferably 0.10 or more and 1.50 or less, and more preferably 0.25 or more and 0.50 or less.

Other Particles

The resin coating layer can also contain other particles.

The particles include inorganic oxide particles, and examples thereof include particles such as silica, alumina, titanium oxide (titania), barium titanate, magnesium titanate, calcium titanate, iron oxide, copper oxide, zinc oxide, tin oxide, chromium oxide, cerium oxide, antimony trioxide, magnesium oxide, zirconium oxide, barium sulfate, barium carbonate, and calcium carbonate.

Electrostatic Charge Image Developer

The developer according to the present exemplary embodiment contains a toner and the carrier according to the present exemplary embodiment.

The developer according to the present exemplary embodiment is prepared by mixing a toner and the carrier according to the present exemplary embodiment, for example, at a preferable mixing ratio. The mixing ratio (mass ratio) between the toner and the carrier, represented by toner:carrier, is, for example, preferably 1:100 to 30:100, and more preferably 3:100 to 20:100.

Electrostatic Charge Image Developing Toner

As the toner, known toners are used without particular restrictions. Examples thereof include a colored toner that contains toner particles containing a binder resin and a colorant, and an infrared-absorbing toner that uses an infrared absorber instead of a colorant. The toner may contain a release agent, various internal additives, an external additive, and the like.

Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

Each of these binder resins may be used alone, or two or more of these binder resins may be used in combination.

As the binder resin, for example, a polyester resin is preferable. Examples of the polyester resin include known polyester resins.

The glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K7121-1987, “Testing methods for transition temperatures of plastics”.

The weight-average molecular weight (Mw) of the polyester resin is, for example, preferably 5,000 or more and 1,000,000 or less, and more preferably 7,000 or more and 500,000 or less. The number-average molecular weight (Mn) of the polyester resin is, for example, preferably 2,000 or more and 100,000 or less. The molecular weight distribution Mw/Mn of the polyester resin is, for example, preferably 1.5 or more and 100 or less, and more preferably 2 or more and 60 or less.

The weight-average molecular weight and the number-average molecular weight of the polyester resin are measured by gel permeation chromatography (GPC). By GPC, the molecular weight is measured using GPC.HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

Colorant

Examples of colorants include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and the like.

One colorant may be used alone, or two or more colorants may be used in combination.

As the colorant, a colorant having undergone a surface treatment as necessary may be used, or a dispersant may be used in combination with the colorant. Furthermore, a plurality of colorants may be used in combination.

The content of the colorant with respect to the total mass of the toner particles is, for example, preferably 1% by mass or more and 30% by mass or less, and more preferably 3% by mass or more and 15% by mass or less.

Release Agent

Examples of the release agent include hydrocarbon-based wax; natural wax such as carnauba wax, rice wax, and candelilla wax; synthetic or mineral⋅petroleum-based wax such as montan wax; ester-based wax such as fatty acid esters and montanic acid esters; and the like. The release agent is not limited to these.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total mass of the toner particles is, for example, preferably 1% by mass or more and 20% by mass or less, and more preferably 5% by mass or more and 15% by mass or less.

Other Additives

Examples of other additives include known additives such as a magnetic material, a charge control agent, and inorganic powder. These additives are incorporated into the toner particles as internal additives.

Characteristics of Toner Particles and the Like

The toner particles may be toner particles that have a single-layer structure or toner particles having a so-called core/shell structure that is configured with a core portion (core particle) and a coating layer (shell layer) covering the core portion. The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The volume-average particle size of the toner particles is measured using COULTER MULTISIZER II (manufactured by Beckman Coulter, Inc.) and using ISOTON-II (manufactured by Beckman Coulter, Inc.) as an electrolytic solution. For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less. The electrolytic solution in which the sample is suspended is subjected to a dispersion treatment for 1 minute with an ultrasonic disperser, and the particle size of particles having a particle size in a range of 2 μm or more and 60 μm or less is measured using COULTER MULTISIZER II with an aperture having an aperture size of 100 μm. The number of particles to be sampled is 50,000.

External Additive

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, MgSO₄, and the like.

The surface of the inorganic particles as an external additive may have undergone, for example, a hydrophobic treatment. The hydrophobic treatment is performed, for example, by immersing the inorganic particles in a hydrophobic agent. The hydrophobic agent is not particularly limited, and examples thereof include a silane-based coupling agent, silicone oil, a titanate-based coupling agent, an aluminum-based coupling agent, and the like. Each of these agents may be used alone, or two or more of these agents may be used in combination.

Usually, the amount of the hydrophobic agent is, for example, 1 part by mass or more and 10 parts by mass or less with respect to 100 parts by mass of the inorganic particles.

Examples of external additives also include resin particles (resin particles such as polystyrene, polymethylmethacrylate, and melamine resins), a cleaning activator (for example, a metal salt of a higher fatty acid represented by zinc stearate or fluorine-based polymer particles), and the like.

The amount of external additives added to the exterior of the toner particles with respect to the toner particles is, for example, preferably 0.01% by mass or more and 5% by mass or less, and more preferably 0.01% by mass or more and 2.0% by mass or less.

Manufacturing Method of Toner

The toner is obtained by manufacturing toner particles and then adding external additives to the exterior of the toner particles. The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). There are no particular restrictions on these manufacturing methods, and known manufacturing methods are adopted. Among the above methods, for example, the aggregation and coalescence method may be used for obtaining toner particles.

Image Forming Apparatus and Image Forming Method

The image forming apparatus/image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralizing unit that neutralizes charge by irradiating the surface of the image holder with charge neutralizing light before charging after the transfer of the toner image.

In a case where the image forming apparatus according to the present exemplary embodiment is the intermediate transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing unit may be a cartridge structure (process cartridge) detachable from the image forming apparatus. As the process cartridge, for example, a process cartridge is preferably used which includes a developing unit that contains the electrostatic charge image developer according to the present exemplary embodiment.

An example of the image forming apparatus according to the present exemplary embodiment will be described below, but the present invention is not limited thereto. Hereinafter, among the parts shown in the drawing, main parts will be described, and others will not be described.

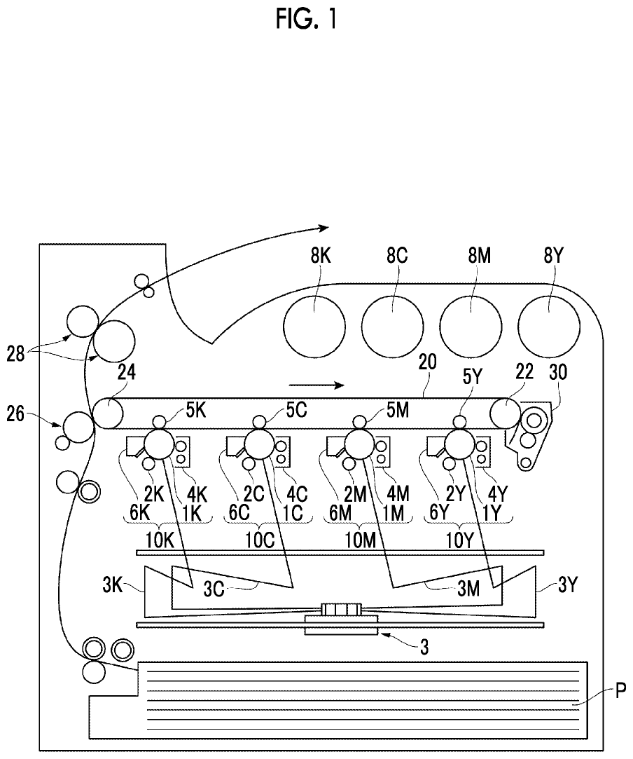

FIG. 1 is a view schematically showing the configuration of the image forming apparatus according to the present exemplary embodiment.

The image forming apparatus shown in FIG. 1 includes first to fourth image forming units 10Y, 10M, 10C, and 10K (image forming means) adopting an electrophotographic method that prints out images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are detachable from the image forming apparatus.

An intermediate transfer belt (an example of an intermediate transfer member) 20 passing through the units 10Y, 10M, 10C, and 10K extends above the units. The intermediate transfer belt 20 is looped around a driving roll 22 and a support roll 24 that are in contact with the inner surface of the intermediate transfer belt 20, and runs toward a fourth unit 10K from a first unit 10Y. Force is applied to the support roll 24 in a direction away from the driving roll 22 by a spring or the like (not shown in the drawing). Tension is applied to the intermediate transfer belt 20 looped over the two rolls. An intermediate transfer belt cleaning device 30 facing the driving roll 22 is provided on the side of the intermediate transfer belt 20 on the surface of the image holder.

Toners of yellow, magenta, cyan, and black, stored in containers of toner cartridges 8Y, 8M, 8C, and 8K are supplied to developing devices (an example of developing units) 4Y, 4M, 4C, and 4K of units 10Y, 10M, 10C, and 10K, respectively.

The first to fourth units 10Y, 10M, 10C, and 10K have the same configuration and perform the same operation. Therefore, in the present specification, as a representative, the first unit 10Y will be described which is placed on the upstream side of the running direction of the intermediate transfer belt and forms a yellow image.

The first unit 10Y has a photoreceptor 1Y that acts as an image holder. Around the photoreceptor 1Y, a charging roll 2Y (an example of a charging unit) that charges the surface of the photoreceptor 1Y at a predetermined potential, an exposure device 3 (an example of an electrostatic charge image forming unit) that exposes the charged surface to a laser beam 3Y based on color-separated image signals to form an electrostatic charge image, a developing device 4Y (an example of a developing unit) that develops the electrostatic charge image by supplying a charged toner to the electrostatic charge image, a primary transfer roll (an example of a primary transfer unit) 5Y that transfers the developed toner image onto the intermediate transfer belt 20, and a photoreceptor cleaning device 6Y (an example of an image holder cleaning unit) that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. A bias power supply (not shown in the drawing) for applying a primary transfer bias is connected to primary transfer rolls 5Y, 5M, 5C, and 5K of each unit. Each bias power supply changes the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with a laser beam, the specific resistance of the portion irradiated with the laser beam changes. Therefore, from an exposure device 3, the laser beam 3Y is radiated to the surface of the charged photoreceptor 1Y according to the image data for yellow transmitted from the control unit not shown in the drawing. As a result, an electrostatic charge image of the yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y is developed as a toner image by the developing device 4Y and visualized.

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). Then, as the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. In the first unit 10Y, the transfer bias is set, for example, to +10 μA under the control of the control unit (not shown in the drawing).

Meanwhile, the residual toner on the photoreceptor 1Y is removed by a photoreceptor cleaning device 6Y and collected.

The primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll 26 (an example of a secondary transfer unit) disposed on the side of the image holding surface of the intermediate transfer belt 20. Meanwhile, via a supply mechanism, recording paper P (an example of a recording medium) is fed at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

The recording paper P onto which the toner image is transferred is transported into a pressure contact portion (nip portion) of a pair of fixing rolls in the fixing device 28 (an example of a fixing unit), the toner image is fixed to the surface of the recording paper P, and a fixed image is formed. The recording paper P on which the color image has been fixed is transported to an output portion, and a series of color image forming operations is finished.

Examples of the recording paper P to which the toner image is to be transferred include plain paper used in electrophotographic copy machines, printers, and the like. Examples of the recording medium also include an OHP sheet and the like, in addition to the recording paper P.

In order to further improve the smoothness of the image surface after fixing, for example, it is preferable that the surface of the recording paper P be also smooth. For instance, coated paper prepared by coating the surface of plain paper with a resin or the like, art paper for printing, and the like are preferably used.

Process Cartridge

The process cartridge according to the present exemplary embodiment will be described.

The process cartridge according to the present exemplary embodiment includes a developing unit which contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment may be configured with a developing unit and, for example, at least one member selected from other units, such as an image holder, a charging unit, an electrostatic charge image forming unit, and a transfer unit, as necessary.

An example of the process cartridge according to the present exemplary embodiment will be shown below, but the present invention is not limited thereto. Hereinafter, among the parts shown in the drawing, main parts will be described, and others will not be described.

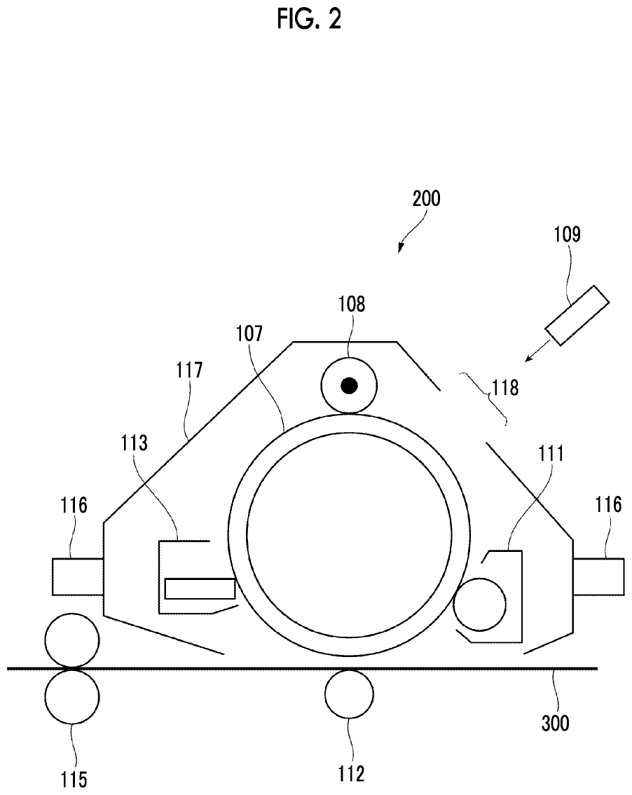

FIG. 2 is a view schematically showing an example of the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of an image holder), a charging roll 108 (an example of a charging unit) that is provided on the periphery of the photoreceptor 107, a developing device 111 (an example of a developing unit), a photoreceptor cleaning device 113 (an example of a cleaning unit), which are integrally combined and held in the housing 117. The process cartridge 200 forms a cartridge in this way.

In FIG. 2, 109 represents an exposure device (an example of an electrostatic charge image forming unit), 112 represents a transfer device (an example of a transfer unit), 115 represents a fixing device (an example of a fixing unit), and 300 represents recording paper (an example of a recording medium).

### EXAMPLES

Hereinafter, exemplary embodiments of the invention will be specifically described based on examples. However, the exemplary embodiments of the invention are not limited to the examples. In the following description, unless otherwise specified, “parts” and “%” are based on mass.

Preparation of Toner
Preparation of Resin Particle Dispersion (1)

| | |
|---|---|
| Ethylene glycol (FUJIFILM Wako Pure Chemical Corporation) | 37 parts |
| Neopentyl glycol (FUJIFILM Wako Pure Chemical Corporation) | 65 parts |
| 1,9-Nonanediol (FUJIFILM Wako Pure Chemical Corporation) | 32 parts |
| Terephthalic acid (manufactured by FUJIFILM Wako Pure | 96 parts |
| Chemical Corporation) | |

The above materials are put in a flask, the temperature is raised to 200° C. for 1 hour, and after it is confirmed that the inside of the reaction system is uniformly stirred, 1.2 parts of dibutyltin oxide is added. The temperature is raised to 240° C. for 6 hours in a state where the generated water is being distilled off, and stirring is continued at 240° C. for 4 hours, thereby obtaining a polyester resin (acid value 9.4 mgKOH/g, weight-average molecular weight 13,000, glass transition temperature 62° C.). The molten polyester resin is transferred as it is to an emulsifying disperser (CAVITRON CD1010, Eurotech Ltd.) at a rate of 100 g/min. Separately, dilute aqueous ammonia having a concentration of 0.37% obtained by diluting the reagent aqueous ammonia with deionized water is put in a tank and transferred to an emulsifying disperser together with the polyester resin at a rate of 0.1 L/min while being heated at 120° C. by a heat exchanger. The emulsifying disperser is operated under the conditions of a rotation speed of a rotor of 60 Hz and a pressure of 5 kg/cm², thereby obtaining a resin particle dispersion (1) having a volume-average particle size of 160 nm and a solid content of 30%.

Preparation of Resin Particle Dispersion (2)

| | |
|---|---|
| Decanedioic acid (Tokyo Chemical Industry Co., Ltd.) | 81 parts |
| Hexandiol (FUJIFILM Wako Pure Chemical Corporation) | 47 parts |

The above materials are put in a flask, the temperature is raised to 160° C. for 1 hour, and after it is confirmed that the inside of the reaction system is uniformly stirred, 0.03 parts of dibutyltin oxide is added. While the generated water is being distilled off, the temperature is raised to 200° C. for 6 hours, and stirring is continued for 4 hours at 200° C. Thereafter, the reaction solution is cooled, solid-liquid separation is performed, and the solid is dried at a temperature of 40° C. under reduced pressure, thereby obtaining a polyester resin (C1) (melting point 64° C., weight-average molecular weight of 15,000).

| | |
|---|---|
| Polyester resin (C1) | 50 parts |
| Anionic surfactant (NEOGEN SC, manufactured by DKS | 2 parts |
| Co., Ltd.) | |
| Deionized water | 200 parts |

The above materials are heated to 120° C., dispersed with a homogenizer (ULTRA-TURRAX T50, manufactured by IKA), and then subjected to a dispersion treatment with a pressure jet-type homogenizer. At a point in time when the volume-average particle size reaches 180 nm, the dispersed resultant is collected, thereby obtaining a resin particle dispersion (2) having a solid content of 20%.

Preparation of Colorant Particle Dispersion (1)

| | |
|---|---|
| Cyan pigment (PigmentBlue 15:3, manufactured by | 10 parts |
| Dainichiseika Color & Chemicals Mfg.Co., Ltd.) | |
| Anionic surfactant (NEOGEN SC, manufactured by DKS | 2 parts |
| Co., Ltd.) | |
| Deionized water | 80 parts |

The above materials are mixed together and dispersed for 1 hour with a high-pressure impact disperser ULTIMIZER (HJP30006, manufactured by SUGINO MACHINE LIMITED), thereby obtaining a colorant particle dispersion (1) having a volume-average particle size of 180 nm and a solid content of 20%.

Preparation of Release Agent Particle Dispersion (1)

| | |
|---|---|
| Paraffin wax (HNP-9, NIPPON SEIRO CO., LTD.) | 50 parts |
| Anionic surfactant (NEOGEN SC, manufactured by DKS | 2 parts |
| Co., Ltd.) | |
| Deionized water | 200 parts |

The above materials are heated to 120° C., dispersed with a homogenizer (ULTRA-TURRAX T50, manufactured by IKA), and then subjected to a dispersion treatment with a pressure jet-type homogenizer. At a point in time when the volume-average particle size reaches 200 nm, the dispersed resultant is collected, thereby obtaining a release agent particle dispersion (1) having a solid content of 20%.

Preparation of Toner (1)

| | | |
|---|---|---|
| Resin particle dispersion (1) | 150 | parts |
| Resin particle dispersion (2) | 50 | parts |
| Colorant particle dispersion (1) | 25 | parts |
| Release agent particle dispersion (1) | 35 | parts |
| Polyaluminum chloride | 0.4 | parts |
| Deionized water | 100 | parts |

The above materials are put in a stainless steel flask, mixed and dispersed together by using a homogenizer (ULTRA-TURRAX T50, IKA), and then heated to 48° C. in an oil bath for heating in a state where the inside of the flask is being stirred. The internal temperature of the reaction system is kept at 48° C. for 60 minutes, and then 70 parts of the resin particle dispersion (1) is slowly added thereto. Thereafter, the pH is adjusted to 8.0 by using a 0.5 mol/L aqueous sodium hydroxide solution, the flask is then sealed, heated to 90° C. while being continuously stirred with a stirring shaft with a magnetic seal, and kept at 90° C. for 30 minutes. Next, the mixture is cooled at a cooling rate of 5° C./min, subjected to solid-liquid separation, and washed with deionized water. Then, the mixture is subjected to solid-liquid separation, redispersed in deionized water at 30° C., and stirred and washed at a rotation speed of 300 rpm for 15 minutes. This washing operation is further repeated 6 times, solid-liquid separation is performed at a point in time when the pH of the filtrate reaches 7.54 and the electrical conductivity reaches 6.5 μS/cm, and vacuum drying is continued for 24 hours, thereby obtaining toner particles (1) having a volume-average particle size of 5.7 μm.

The toner particles (1) (100 parts) and 2.5 parts of hydrophobic silica (having a surface having undergone a hydrophobic treatment with hexamethyldisilazane, average primary particle size of 40 nm) are mixed together by a Henschel mixer, thereby obtaining a toner (1).

Preparation of Carrier

Ferrite Particles

Fe₂O₃ (1,597 parts), 712 parts of Mn(OH)₂, 116 parts of Mg(OH)₂, 20 parts of SrCO₃, and 30 parts of CaCO₃ are mixed together, and a dispersant, water, and zirconia beads having a diameter of 1 mm are added thereto, followed by disintegration and mixing using a sand mill. The zirconia beads are separated by filtration, and the filtrate is dried and then temporarily baked using a rotary kiln under the conditions of rotation speed of 20 rpm/temperature of 970° C./2 hours. A dispersant and water are added to the obtained temporarily baked product, and 8 parts of polyvinyl alcohol is further added thereto, followed by pulverization and mixing for 5 hours using a wet ball mill. The volume-average particle size of the obtained pulverized product is 1.2 μm. Then, the product is made into granules having a particle size of 40 μm by using a spray dryer. The obtained granulated product is permanently baked using an electric furnace in an oxygen/nitrogen mixed atmosphere having an oxygen concentration of 1% by volume under conditions of temperature of 1,400° C./4 hours. The obtained baked product is disintegrated and classified, thereby obtaining ferrite particles. The volume-average particle size of the ferrite particles is 35 μm.

Strontium Titanate Particles (1)

Metatitanic acid which is a desulfurized and deflocculated titanium source is collected in an amount of 0.7 mol as TiO₂ and put in a reaction vessel. Then, 0.77 mol of an aqueous strontium chloride solution is added to the reaction vessel such that the molar ratio of SrO/TiO₂ is 1.1. Thereafter, a solution obtained by dissolving lanthanum oxide in nitric acid is added to the reaction vessel, in an amount that makes the amount of lanthanum 2.5 mol with respect to 100 mol of strontium. The initial TiO₂ concentration in the mixed solution of the three materials is adjusted to 0.75 mol/L.

Subsequently, the mixed solution is stirred and heated to 90° C., 153 mL of a 10N aqueous sodium hydroxide solution is added thereto for 1 hour in a state where the mixed solution is being stirred at a liquid temperature kept at 90° C., and the obtained reaction solution is continuously stirred for 1 hour at a liquid temperature kept at 90° C. The reaction solution is then cooled to 40° C., hydrochloric acid is added thereto until the pH reaches 5.5, and the reaction solution is stirred for 1 hour. Thereafter, decantation and redispersion in water are repeated to wash the precipitate. Hydrochloric acid is added to the slurry containing the washed precipitate such that the pH is adjusted to 6.5, and the solids are separated by filtration and dried. i-Butyltrimethoxysilane (i-BTMS) in an ethanol solution is added to the dried solids, in an amount that makes the amount of the i-BTMS 20 parts with respect to 100 parts of the solids, followed by stirring for 1 hour. The solids are separated by filtration and dried in the atmosphere at 130° C. for 7 hours, thereby obtaining strontium titanate particles (1).

The obtained strontium titanate particles (1) have a volume-average particle size of 25 nm determined by the method described above, and contain lanthanum as a dopant and i-BTMS as a surface treatment agent.

Strontium Titanate Particles (2)

Strontium titanate particles (2) having a volume-average particle size of 5 nm are obtained in the same manner as the strontium titanate particles (1), except that a solution prepared by dissolving lanthanum oxide in nitric acid is not added.

Strontium Titanate Particles (3)

Strontium titanate particles (3) having a volume-average particle size of 5 nm are obtained in the same manner as the strontium titanate particles (1), except that the time taken for adding 10N aqueous sodium hydroxide solution dropwise is changed to 0.5 hours.

Strontium Titanate Particles (4)

Strontium titanate particles (4) having a volume-average particle size of 8 nm are obtained in the same manner as the strontium titanate particles (1), except that the time taken for adding 10N aqueous sodium hydroxide solution dropwise is changed to 0.7 hours.

Strontium Titanate Particles (5)

Strontium titanate particles (5) having a volume-average particle size of 20 nm are obtained in the same manner as the strontium titanate particles (1), except that the time taken for adding 10N aqueous sodium hydroxide solution dropwise is changed to 1.7 hours.

Strontium Titanate Particles (6)

Strontium titanate particles (6) having a volume-average particle size of 50 nm are obtained in the same manner as the strontium titanate particles (1), except that the time taken for adding 10N aqueous sodium hydroxide solution dropwise is changed to 4 hours.

Strontium Titanate Particles (7)

Strontium titanate particles (7) having a volume-average particle size of 55 nm are obtained in the same manner as the strontium titanate particles (1), except that the time taken for adding 10N aqueous sodium hydroxide solution dropwise is changed to 4.5 hours.

Preparation of Nitrogen-Containing Resin Particles

As nitrogen-containing resin particles, crosslinked melamine resin particles having volume-average particle sizes of 120 nm, 150 nm, and 230 nm are used.

### Example 1

| | | |
|---|---|---|
| Ferrite particles | 100 | parts |
| Strontium titanate particles (1) | 1.55 | parts |
| (30% by mass with respect to the total mass of the resin | | |
| coating layer) | | |
| Nitrogen-containing resin particles (volume-average particle | 0.55 | parts |
| size 150 nm) (10% by mass with respect to the total mass | | |
| of the resin coating layer) (mass ratio of nitrogen-containing | | |
| resin particles/nitrogen-containing silica particles: 0.33) | | |
| Cyclohexyl methacrylate/methyl methacrylate copolymer | 3 | parts |
| (Copolymerization ratio 95 mol:5 mol) | | |
| Toluene | 14 | parts |

Among the above materials, the strontium titanate particles (1), the nitrogen-containing resin particles, the cyclohexyl methacrylate/methyl methacrylate copolymer, the toluene, and glass beads (diameter 1 mm, same amount as toluene) are put in a sand mill (Kansai Paint Co., Ltd.), and stirred at a rotation speed of 1,200 rpm for 30 minutes, thereby obtaining a solution (1) for forming a resin layer.

Ferrite particles are put in a vacuum deaeration-type kneader, the solution (1) for forming a resin layer is added thereto, and the mixture is heated and depressurized while being stirred, such that the toluene is distilled off and the ferrite particles are coated with a resin. Then, fine powder and coarse powder are removed by an Elbow Jet, thereby obtaining a carrier.

### Examples 2 to 23

Carriers of each example are prepared in the same manner as in Example 1, except that the type and content of the strontium titanate particles and the nitrogen-containing resin particles are set according to the specifications shown in Table 1.

### Comparative Examples 1 and 2

Carriers are prepared in the same manner as in Example 1, except that the type and content of the strontium titanate particles and the nitrogen-containing resin particles are set according to the specifications shown in Table 1.

### Comparative Example 3

Carriers are prepared in the same manner as in Example 1, except that the strontium titanate particles are replaced with silica particles (HG-09) with a higher resistance having a volume-average particle size of 22 nm manufactured by Tokuyama Corporation.

Properties of Carrier Particles

For the carriers obtained in Examples 1 to 23 and Comparative Examples 1 to 3, the following values are determined and listed in Table 1.
Proportion of Strontium Atoms within Surface of Resin Coating Layer

The proportion of strontium atoms within the surface of the resin coating layer is measured according to the method described above.
Resin Coating Layer Thickness T (μm)

The resin coating layer thickness T is measured according to the method described above.
D/T (volume-average particle size of strontium titanate particles/resin coating layer thickness)
D/T is determined from a volume-average particle size D (nm) of the strontium titanate particles and the resin coating layer thickness T (nm) described above.
Sr1/C1, Sr2/C2, and (Sr2/C2−Sr1/C1)

Sr1/C1, Sr2/C2, and (Sr2/C2−Sr1/C1) are measured according to the method described above.
Mass P of nitrogen-containing resin particles/mass W of strontium titanate particles

P/W is determined from the mass P of the nitrogen-containing resin particles and the mass W of the strontium titanate particles.

Preparation of Developer

Each of the carriers (100 parts) of Examples 1 to 23 and Comparative Examples 1 to 3 and 8.5 parts of the toner (1) are mixed together, thereby preparing 26 types of developers. The prepared developers are used for the following evaluation of charge retention properties.

Evaluation of Charge Retention Properties of Developer

Each developer is put into a developing device at the position of black in an image forming apparatus (“Iridesse Production Press” manufactured by FUJIFILM Business Innovation Corp.). In a high-humidity environment (80° C.), a total of 50,000 sheets are printed by the image forming apparatus under the conditions of 100 sheets of A4 paper/job, an interval of 30 minutes, and a high coverage (proportion of images within the surface of a piece of paper: 20%), and the weight of the toner cartridge is measured whenever 5,000 sheets have been printed.

The ratio of the toner consumption after the actual printing of 50,000 sheets to the predicted line showing the toner consumption predicted from the weights of the toner cartridge measured at the initial five points is calculated, and the toner consumption is evaluated based on the following criteria. The closer the ratio is to 1, the higher the charge retention properties of the developer are, which means the charge retention properties are excellent.

The results are shown in Table 1.
A: The ratio of carrier consumption is less than 1.1.
B: The ratio of carrier consumption is 1.1 or more and less than 1.2.
C: The ratio of carrier consumption is 1.2 or more and less than 1.5.
D: The ratio of carrier consumption is 1.5 or more.

As shown in Table 1, it has been found that the electrostatic charge image developing carriers of examples are further inhibited from experiencing deterioration of charge retention properties, compared to electrostatic charge image developing carriers of comparative examples.

TABLE 1

| | St [symbol] titan [symbol] particles | | | | | | |
|---|---|---|---|---|---|---|---|
| | | | Proportion of | | | | |
| | | | S [symbol] [symbol] within | | Resin | | |
| | | Cont [symbol] | surface | Volume- | coating | | |
| | Type of | in resin | of resin | average | layer | | |
| | stronti [symbol] m | coating | costing | particle | thickness | | |
| | ti [symbol] | layer (%) | layer (%) | size D ( [symbol] m) | T ( [symbol] m) | D/T | S [symbol] /C1 |
| Example 1 | (1) | 30 | 0.6 | 25 | 1,200 | 0.0208 | 0.00857 |
| Example 2 | (1) | 10 | 0.2 | 25 | 1,200 | 0.0208 | 0.00286 |
| Example 3 | (1) | 20 | 0.4 | 25 | 1,200 | 0.0208 | 0.00571 |
| Example 4 | (1) | 40 | 0.8 | 25 | 1,200 | 0.0208 | 0.01143 |
| Example 5 | (1) | 55 | 1.0 | 25 | 1,200 | 0.0208 | 0.01429 |
| Example 6 | (2) | 30 | 0.6 | 25 | 1,200 | 0.0208 | 0.00857 |
| Example 7 | (1) | 30 | 0.6 | 25 | 1,200 | 0.0208 | 0.00857 |
| Example 8 | (3) | 30 | 0.6 | 5 | 1,200 | 0.0042 | 0.00857 |
| Example 9 | (4) | 30 | 0.6 | 8 | 1,200 | 0.0067 | 0.00857 |
| Example 10 | (5) | 30 | 0.6 | 20 | 1,200 | 0.0167 | 0.00857 |
| Example 11 | (6) | 30 | 0.6 | [symbol] 0 | 1,200 | 0.0417 | 0.00857 |
| Example 12 | (7) | 30 | 0.6 | 55 | 1,200 | 0.0458 | 0.00857 |
| Example 13 | (1) | 30 | 0.6 | 25 | 1,000 | 0.0250 | 0.00857 |
| Example 14 | (1) | 30 | 0.6 | 25 | 1,200 | 0.0208 | 0.00857 |
| Example 15 | (1) | 30 | 0.6 | 25 | 1,500 | 0.0167 | 0.00857 |
| Example 16 | (1) | 30 | 0.6 | 25 | 1,200 | 0.0208 | 0.00857 |
| Example 17 | (1) | 30 | 0.6 | 25 | 1,200 | 0.0208 | 0.00857 |
| Example 18 | (1) | 30 | 0.6 | 25 | 1,200 | 0.0208 | 0.00857 |
| Example 19 | (1) | 30 | 0.6 | 25 | 1,200 | 0.0208 | 0.00857 |
| Example 20 | (1) | 30 | 0.6 | 25 | 1,200 | 0.0208 | 0.00857 |
| Example 21 | (1) | 30 | 0.6 | 25 | 1,200 | 0.0208 | 0.00857 |
| Example 22 | (1) | 30 | 0.6 | 25 | 1,200 | 0.0208 | 0.00857 |
| Example 23 | (1) | 30 | 0.6 | 25 | 1,200 | 0.0208 | 0.00857 |
| Comparative | (1) | 5 | 0.1 | 25 | 1,200 | 0.0208 | 0.00143 |
| Example 1 | | | | | | | |
| Comparative | (1) | 60 | 1.2 | 25 | 1,200 | 0.0208 | 0.01714 |
| Example 2 | | | | | | | |
| Comparative | Silica | 30 | 0.0 | 22 | 1,200 | 0.0183 | 0.00000 |
| Example 3 | | | | | | | |

| | | | | | Mass P of | |
|---|---|---|---|---|---|---|
| | | | | | nitrogen- | |
| | | | Nitrogen-containing | | containing | |
| | | | resin particles | | resin | |
| | | | Volume- | Content | particles | |
| | | | average | in resin | Mass W of | |
| | | | particle | costing | strontium | |
| | | S [symbol] 2/C2 − | size | layer | titan [symbol] | |
| | S [symbol] 2/C2 | S [symbol] /Cl | (nm) | (%) | particles | Evaluation |
| Example 1 | 0.01714 | 0.00857 | 150 | 10 | 0.33 | A |
| Example 2 | 0.01714 | 0.01429 | 150 | 10 | 1.00 | B |
| Example 3 | 0.01714 | 0.01143 | 150 | 10 | 0.50 | A |
| Example 4 | 0.01714 | 0.00571 | 150 | 10 | 0.25 | A |
| Example 5 | 0.01714 | 0.00286 | 150 | 10 | 0.18 | B |
| Example 6 | 0.01714 | 0.00857 | 150 | 10 | 0.33 | C |
| Example 7 | 0.01714 | 0.00857 | Nitrogen-containing resin particles are not used. | | | C |
| Example 8 | 0.01714 | 0.00857 | 150 | 10 | 0.33 | B |
| Example 9 | 0.01714 | 0.00857 | 150 | 10 | 0.33 | A |
| Example 10 | 0.01714 | 0.00857 | 150 | 10 | 0.33 | A |
| Example 11 | 0.01714 | 0.00857 | 150 | 10 | 0.33 | B |
| Example 12 | 0.01714 | 0.00857 | 150 | 10 | 0.33 | C |
| Example 13 | 0.01714 | 0.00857 | 150 | 10 | 0.33 | A |
| Example 14 | 0.01714 | 0.00857 | 150 | 10 | 0.33 | A |
| Example 15 | 0.01714 | 0.00857 | 150 | 10 | 0.33 | B |
| Example 16 | 0.01714 | 0.00857 | 120 | 10 | 0.33 | B |
| Example 17 | 0.01714 | 0.00857 | 150 | 10 | 0.33 | A |
| Example 18 | 0.01714 | 0.00857 | 200 | 10 | 0.33 | A |
| Example 19 | 0.01714 | 0.00857 | 230 | 10 | 0.33 | B |
| Example 20 | 0.01714 | 0.00857 | 150 | 5 | 0.17 | B |
| Example 21 | 0.01714 | 0.00857 | 150 | 10 | 0.33 | A |
| Example 22 | 0.01714 | 0.00857 | 150 | 20 | 0.67 | A |
| Example 23 | 0.01714 | 0.00857 | 150 | 30 | 1.00 | B |
| Comparative | 0.01714 | 0.01571 | 150 | 10 | 2.00 | D |
| Example 1 | | | | | | |
| Comparative | 0.01714 | 0.00000 | 150 | 10 | 0.17 | D |
| Example 2 | | | | | | |
| Comparative | 0.01714 | 0.01714 | 150 | 10 | 0.33 | D |
| Example 3 | | | | | | |

[symbol]

indicates data missing or illegible when filed

Supplementary Note

(((1)))

An electrostatic charge image developing carrier comprising: a core material; and

a resin coating layer that contains strontium titanate particles and coats the core material,

wherein a content of the strontium titanate particles is 10% by mass or more and 55% by mass or less with respect to a total mass of the resin coating layer, and

a proportion of strontium atoms within a surface of the resin coating layer, the proportion being determined by X-ray photoelectron spectroscopy, is 0.2 at % or more and 1.0 at % or less.

(((2)))

The electrostatic charge image developing carrier according to (((1))),

wherein a volume-average particle size of the strontium titanate particles is 5 nm or more and 50 nm or less.

(((3)))

An electrostatic charge image developing carrier according to (((1))) or (((2))),

wherein in the resin coating layer, in a case where C1 represents carbon atoms derived from all components contained in a first region within 300 nm from a surface of the carrier in a depth direction, Sr1 represents strontium atoms derived from the strontium titanate particles contained in the first region, C2 represents carbon atoms derived from all components contained in a second region which is 300 nm away from the surface of the carrier in the depth direction and within 600 nm from the surface of the carrier in the depth direction, and Sr2 represents strontium atoms derived from the strontium titanate particles contained in the second region, a ratio of Sr1 to C1 (Sr1/C1) is lower than a ratio of Sr2 to C2 (Sr2/C2).

(((4)))

The electrostatic charge image developing carrier according to any one of (((1))) to (((3))),

wherein in a case where D (nm) represents the volume-average particle size of the strontium titanate particles, and T (nm) represents a thickness of the resin coating layer, D/T is 0.0033 or more and 0.050 or less.

(((5)))

The electrostatic charge image developing carrier according to any one of (((1))) to (((4))),

wherein the strontium titanate particles are strontium titanate particles doped with metal atoms other than titanium and strontium.

(((6)))

The electrostatic charge image developing carrier according to (((5))),

wherein the strontium titanate particles are strontium titanate particles doped with metal atoms having an electronegativity of 2.0 or less.

(((7)))

The electrostatic charge image developing carrier according to (((5))) or (((6))),

wherein the strontium titanate particles are lanthanum-doped strontium titanate particles.

(((8)))

The electrostatic charge image developing carrier according to any one of (((1))) to (((7))),

wherein the resin coating layer contains nitrogen-containing resin particles.

(((9)))

The electrostatic charge image developing carrier according to (((8))),

wherein a volume-average particle size of the nitrogen-containing resin particles is 120 nm or more and 230 nm or less.

(((10)))

The electrostatic charge image developing carrier according to (((8))) or (((9))),

wherein a content of the nitrogen-containing resin particles is 5% by mass or more and 30% by mass or less with respect to the total mass of the resin coating layer.

(((11)))

The electrostatic charge image developing carrier according to (((10))),

wherein a mass ratio P/W of a mass P of the nitrogen-containing resin particles to a mass W of the strontium titanate particles is 0.091 or more and 3.00 or less.

(((12)))

The electrostatic charge image developing carrier according to any one of (((1))) to (((11))),

wherein the core material is ferrite particles.

(((13)))

The electrostatic charge image developing carrier according to any one of (((1))) to (((12))),

wherein the content of the strontium titanate particles is 15% by mass or more and 45% by mass or less with respect to the total mass of the resin coating layer.

(((14)))

The electrostatic charge image developing carrier according to any one of (((1))) to (((13))),

wherein the proportion of strontium atoms within the surface of the resin coating layer, the proportion being determined by X-ray photoelectron spectroscopy, is 0.4 at % or more and 0.8 at % or less.

(((15)))

The electrostatic charge image developer comprising:

an electrostatic charge image developing toner; and

the electrostatic charge image developing carrier according to any one of (((1))) to (((14))).

(((16)))

A process cartridge comprising:

a developing unit that contains the electrostatic charge image developer according to (((15))) and develops an electrostatic charge image formed on a surface of an image holder as a toner image by using the electrostatic charge image developer,

wherein the process cartridge is detachable from an image forming apparatus.

(((17)))

An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to (((15))) and develops the electrostatic charge image formed on the surface of the image holder as a toner image by using the electrostatic charge image developer;
a transfer unit that transfers the toner image formed on the surface of the image holder to a surface of a recording medium; and
a fixing unit that fixes the toner image transferred to the surface of the recording medium.

(((18)))

An image forming method comprising:
charging a surface of an image holder;
forming an electrostatic charge image on the charged surface of the image holder;
developing the electrostatic charge image formed on the surface of the image holder as a toner image by using the electrostatic charge image developer according to (((15)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing carrier comprising:
a core material; and
a resin coating layer that contains strontium titanate particles and coats the core material,
wherein a content of the strontium titanate particles is 10% by mass or more and 55% by mass or less with respect to a total mass of the resin coating layer, and
a proportion of strontium atoms within a surface of the resin coating layer, the proportion being determined by X-ray photoelectron spectroscopy, is 0.2 at % or more and 1.0 at % or less.

2. The electrostatic charge image developing carrier according to claim 1,
wherein a volume-average particle size of the strontium titanate particles is 5 nm or more and 50 nm or less.

3. The electrostatic charge image developing carrier according to claim 2,
wherein in the resin coating layer, in a case where C1 represents carbon atoms derived from all components contained in a first region within 300 nm from a surface of the carrier in a depth direction, Sr1 represents strontium atoms derived from the strontium titanate particles contained in the first region, C2 represents carbon atoms derived from all components contained in a second region which is 300 nm away from the surface of the carrier in the depth direction and within 600 nm from the surface of the carrier in the depth direction, and Sr2 represents strontium atoms derived from the strontium titanate particles contained in the second region, a ratio of Sr1 to C1 (Sr1/C1) is lower than a ratio of Sr2 to C2 (Sr2/C2).

4. The electrostatic charge image developing carrier according to claim 2,
wherein in a case where D (nm) represents the volume-average particle size of the strontium titanate particles, and T (nm) represents a thickness of the resin coating layer, D/T is 0.0033 or more and 0.050 or less.

5. The electrostatic charge image developing carrier according to claim 1,
wherein the strontium titanate particles are strontium titanate particles doped with metal atoms other than titanium and strontium.

6. The electrostatic charge image developing carrier according to claim 5,
wherein the strontium titanate particles are strontium titanate particles doped with metal atoms having an electronegativity of 2.0 or less.

7. The electrostatic charge image developing carrier according to claim 6,
wherein the strontium titanate particles are lanthanum-doped strontium titanate particles.

8. The electrostatic charge image developing carrier according to claim 1,
wherein the resin coating layer contains nitrogen-containing resin particles.

9. The electrostatic charge image developing carrier according to claim 8,
wherein a volume-average particle size of the nitrogen-containing resin particles is 120 nm or more and 230 nm or less.

10. The electrostatic charge image developing carrier according to claim 8,
wherein a content of the nitrogen-containing resin particles is 5% by mass or more and 30% by mass or less with respect to the total mass of the resin coating layer.

11. The electrostatic charge image developing carrier according to claim 10,
wherein a mass ratio P/W of a mass P of the nitrogen-containing resin particles to a mass W of the strontium titanate particles is 0.091 or more and 3.00 or less.

12. The electrostatic charge image developing carrier according to claim 1,
wherein the core material is ferrite particles.

13. The electrostatic charge image developing carrier according to claim 1,
wherein the content of the strontium titanate particles is 15% by mass or more and 45% by mass or less with respect to the total mass of the resin coating layer.

14. The electrostatic charge image developing carrier according to claim 1,
wherein the proportion of strontium atoms within the surface of the resin coating layer, the proportion being determined by X-ray photoelectron spectroscopy, is 0.4 at % or more and 0.8 at % or less.

15. An electrostatic charge image developer comprising:
an electrostatic charge image developing toner; and
the electrostatic charge image developing carrier according to claim 1.

16. The electrostatic charge image developer comprising:
an electrostatic charge image developing toner; and
the electrostatic charge image developing carrier according to claim 2.

17. The electrostatic charge image developer comprising:
an electrostatic charge image developing toner; and
the electrostatic charge image developing carrier according to claim 3.

18. A process cartridge comprising:
a developing unit that contains the electrostatic charge image developer according to claim 15 and develops an electrostatic charge image formed on a surface of an image holder as a toner image by using the electrostatic charge image developer,
wherein the process cartridge is detachable from an image forming apparatus.

19. An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to claim 15 and develops the electrostatic charge image formed on the surface of the image holder as a toner image by using the electrostatic charge image developer;
a transfer unit that transfers the toner image formed on the surface of the image holder to a surface of a recording medium; and
a fixing unit that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image by using the electrostatic charge image developer according to claim 15;
transferring the toner image formed on the surface of the image holder to a surface of a recording medium; and
fixing the toner image transferred to the surface of the recording medium.
